(19) United States
(12) Patent Application Publication
(10) Pub. No.: US 2025/0103258 A1
(43) Pub. Date: Mar. 27, 2025

(54) IMAGE FORMING APPARATUS, METHOD OF CONTROLLING IMAGE FORMING APPARATUS, AND STORAGE MEDIUM

(71) Applicant: CANON KABUSHIKI KAISHA, Tokyo (JP)

(72) Inventor: NOBUAKI MIYAHARA, Ibaraki (JP)

(21) Appl. No.: 18/890,319

(22) Filed: Sep. 19, 2024

(30) Foreign Application Priority Data
Sep. 25, 2023 (JP) 2023-161630

(51) Int. Cl. G06F 3/12

(52) U.S. Cl. CPC G06F 3/1257; G06F 3/1205; G06F 3/1267

(57) ABSTRACT

In an image forming apparatus, in a case where a mode of storing print data received by a reception unit and printing the stored print data after acceptance of a print instruction from a user is set and a format of the received print data is a first format, control is performed to store the print data in the first format in a first storage unit, and in a case where the mode is set and the format of the received print data is a second format, control is performed to store the print data in the second format in the second storage unit.

### BACKGROUND

### Field of the Disclosure

The present disclosure relates to an image forming apparatus, a method of controlling the image forming apparatus, and a storage medium.

### Description of the Related Art

An image forming apparatus capable of processing print data in a plurality of page description languages (PDLs) and a print format (job ticket), such as a job definition format (JDF), to perform printing has been conventionally known. There is also an image forming apparatus having a hold function of temporarily storing these pieces of print data in a storage device, such as a hard disk, and starting printing in response to a user instruction from an operation unit. With the hold function, it is possible to check print settings of a print job and change a setting on the operation unit of the image forming apparatus. Hence, even for a complicated print job, such as a print job in which a different type of paper is designated per page range, it is possible to make optimal settings in the image forming apparatus, for example, by making a paper setting while checking the print settings.

With an aim of increasing security and preventing a print product from being left, among image forming apparatuses in recent years, there is an image forming apparatus in which a forced hold mode can be set as an operation mode (see Japanese Patent Application Laid-Open No. 2015-104867). The forced hold mode refers to what is called a hold print mode in which, even if print data received from a personal computer (PC) instructs the image forming apparatus to print the print data, the print data is forcibly temporarily stored in a hard disk without being printed. The print data that has been forcibly held is printed when a user, who has issued a transmission instruction on the PC, issues a print instruction with use of an operation panel in front of the image forming apparatus.

However, since the forced hold mode is directed to the increase of security, it is not possible to check detailed print settings or change a setting with respect to a print job that has been forcibly held. Hence, in a case were a job having complicated print settings, such as a JDF print job, is forcibly held, it is not possible to check print settings afterward on the operation unit of the image forming apparatus. Furthermore, there is also an issue that it is difficult to make settings of the image forming apparatus, such as a paper setting, optimal for the print job on the operation unit of the image forming apparatus.

### SUMMARY

According to embodiments of the present disclosure, an image forming apparatus includes a first storage unit configured to store print data, a print setting of the print data being unchangeable by a user, a second storage unit configured to store print data, a print setting of the print data being changeable by the user, a reception unit configured to receive print data, and a control unit configured to in a case where a mode of storing the print data received by the reception unit and printing the stored print data after acceptance of a print instruction from the user is set and a format of the print data received by the reception unit is a first format, perform control to store the print data in the first format in the first storage unit, and in a case where the mode is set and the format of the print data received by the reception unit is a second format, perform control to store the print data in the second format in the second storage unit.

Further features of the present disclosure will become apparent from the following description of exemplary embodiments with reference to the attached drawings.

### BRIEF DESCRIPTION OF THE DRAWINGS

FIG. 1 is an overall configuration diagram of a print system.

FIG. 2 is a hardware configuration diagram of an image forming apparatus.

FIG. 3 is an allocation map of a storage region of a hard disk.

FIG. 4 illustrates a hold print screen.

FIG. 5 illustrates a hold print screen.

FIG. 6 illustrates a hold print settings screen.

FIG. 7 illustrates a setting screen for a forced hold mode.

FIG. 8 is a diagram illustrating data of a print job from a personal computer (PC).

FIG. 9 is a flowchart illustrating a processing procedure at the time of reception of print data.

### DESCRIPTION OF THE EMBODIMENTS

Exemplary embodiments of the present disclosure will be described below with reference to the accompanying drawings. However, constituent elements described in the exemplary embodiments are merely examples and are not intended to limit the scope of the present disclosure.

In the present exemplary embodiment, a description will be provided of processing of determining a storage region (a forced hold region, a hold region, or the like) for print data transmitted from an information processing terminal (hereinafter referred to as a “PC”) 102 in an image forming apparatus 101 that operates in a forced hold mode.

### Overall Configuration of Print System

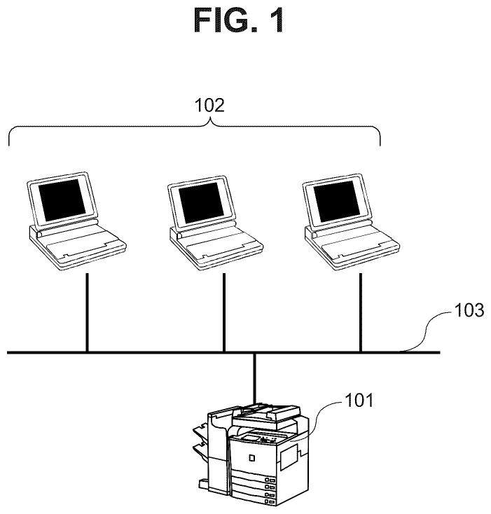

FIG. 1 illustrates an overall configuration of a print system.

The image forming apparatus 101 is what is called a multi-function peripheral (MFP) in which a scanner and a printer are integrated. The image forming apparatus 101 has a function of accumulating (hereinafter also referred to as “holding”) data of a print job transmitted from the PC 102 that is an information processing terminal in a storage device, such as a hard disk.

The PC 102 has a function of generating data for printing and transmitting the data for printing to the image forming apparatus 101 via a network 103.

In the present exemplary embodiment, the description is provided by assuming that the image forming apparatus 101 is a multi-function peripheral including a scanner and a printer, but the image forming apparatus 101 may also be a printer capable of processing print data. Additionally, the hold print system may be a system that holds print data not in the hard disk in the image forming apparatus 101, but in an external hard disk connected to the image forming apparatus 101. Furthermore, the hold print system may have a configuration in which print data is held in a file server, such as a network attached storage (NAS), connected to the network 103, or a configuration in which print data is held in a server that provides a cloud service on the Internet.

### Hardware Configuration of Image Forming Apparatus

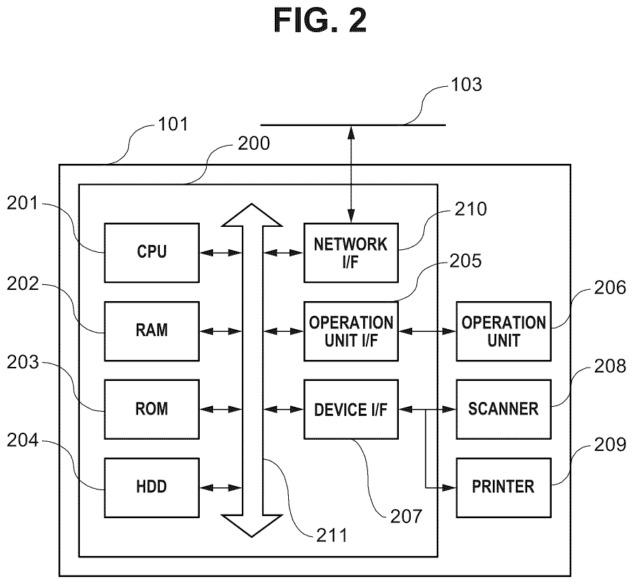

FIG. 2 is a diagram illustrating a hardware configuration of the image forming apparatus 101.

The image forming apparatus 101 includes a control unit 200, an operation unit 206, a scanner 208, and a printer 209.

The control unit 200 includes a central processing unit (CPU) 201, a random-access memory (RAM) 202, a read-only memory (ROM) 203, a hard disk drive (HDD) 204, an operation unit interface (I/F) 205, a device I/F 207, and a network I/F 210, which are communicably connected to each other via a bus 211.

The CPU 201 executes various kinds of information processing in accordance with a control program, and controls the operation unit 206, the scanner 208, and the printer 209. Additionally, the CPU 201 controls the network I/F 210 to perform processing of communicating with an external apparatus.

The RAM 202 is a volatile storage device, and functions as a work memory to be used by the CPU 201 to execute various kinds of information processing.

The ROM 203 is a non-volatile storage device and stores various kinds of control programs and setting values.

The HDD 204 has a forced hold region 301 and a hold region 302, which will be described below, and accumulates data of received print jobs. Additionally, the HDD 204 stores a computer-readable program for execution of a flowchart, which will be described below, setting values for determination of an operation mode of the image forming apparatus 101, and the like. In the present exemplary embodiment, a description is provided of the HDD 204 as an example of a storage means that stores print data, but the storage means is not limited to the HDD 204 and may be a non-volatile storage means, such as a solid-state drive (SSD).

A program stored in the ROM 203 or the HDD 204 is transferred to the RAM 202 and executed by the CPU 201. The image forming apparatus 101 operates in accordance with setting values transferred from the ROM 203 or the HDD 204 to the RAM 202.

The operation unit I/F 205 monitors a user input from the operation unit 206 and transmits input information to the CPU 201. Additionally, the operation unit I/F 205 controls the operation unit 206 to display information in accordance with an instruction from the CPU 201.

The operation unit 206 is an input device that accepts a user operation from a touch panel, a key, or the like, and is also a display device, such as a light emitting diode (LED) display and a liquid crystal display (LCD). The operation unit 206 may be a touch panel display that serves as both the input device and the display device. The operation unit 206 accepts input of a username and a password as authentication information for authentication processing and accepts input for starting printing of print data held in the HDD 204. The input of the authentication information may be accepted by, instead of the operation unit 206, an integrated circuit (IC) card reader (not illustrated).

The device I/F 207 is an interface for connection with the scanner 208 or the printer 209. The device I/F 207 receives image data from the scanner 208 or transmits image data to the printer 209.

The scanner 208 is a device that irradiates a document with light and reads reflected light as digital data. The scanner 208 includes a platen glass for reading a document one surface by one surface. Additionally, an auto document feeder (ADF) is mounted thereon to continuously read a plurality of stacked sheets of the document.

The printer 209 is a device that prints an image on a sheet using an electrophotographic method, and includes a paper feeding mechanism for taking out paper from a paper tray, a mechanism for transferring and fixing an image, and a paper discharge mechanism for discharging paper from the inside of the image forming apparatus 101 to the outside of the image forming apparatus 101. Additionally, as an additional function of the printer 209, there is a finishing mechanism. The finishing mechanism is called a finisher or the like. The finishing mechanism includes a mechanism for sorting printed products in units of copies, a mechanism for stapling, and a mechanism for folding the printed products.

The image forming apparatus 101 uses the scanner 208 and the printer 209 to provide a copy function. The CPU 201 causes the scanner 208 to read an image, executes image processing on image data read by the scanner 208, and causes the printer 209 to print the image data subjected to the image processing. The image processing may be executed by image processing hardware other than the CPU 201. The image processing enables 2-in-1 printing in which the image data is processed so that images respectively read from two sheets of a document are printed on one sheet.

Additionally, the image forming apparatus 101 provides a transmission function of transmitting image data read by the scanner 208 via the network I/F 210, and a fax function of transmitting the image data read by the scanner 208 via a telephone line (not illustrated). In a case where the image forming apparatus 101 does not provide the copy function, the transmission function, and the fax function, the image forming apparatus 101 need not include the scanner 208.

The network I/F 210 controls network communication in accordance with an instruction from the CPU 201. The network communication may be wired communication, such as Ethernet®, or wireless communication, such as Wireless Fidelity (Wi-Fi) and Bluetooth®. Additionally, the image forming apparatus 101 may include a universal serial bus (USB) I/F that performs communication via a USB cable.

The CPU 201, the RAM 202, the ROM 203, the HDD 204, the operation unit I/F 205, the device I/F 207, and the network I/F 210 are connected to the bus 211.

The program to be executed by the CPU 201 is stored in the ROM 203 or the HDD 204, and is loaded into the RAM 202 when the image forming apparatus 101 is started or provides a function. The CPU 201 executes a program loaded in the RAM 202.

The CPU 201 controls the operation unit I/F 205 to display a message or an operation screen on the operation unit 206 and acquire information input to the operation unit 206 by the user.

The CPU 201 performs authentication processing for allowing the user who uses the image forming apparatus 101 to log in to the image forming apparatus 101. Specifically, the CPU 201 instructs the operation unit 206 to display an authentication screen for determination about whether the user is an authorized user who is permitted to use the image forming apparatus 101. Subsequently, the CPU 201 acquires authentication information (a username and a password) input by the user using the operation unit 206, and performs user authentication based on the authentication information. In a case where the user authentication succeeds, the CPU 201 acquires setting values associated with the user, and controls a screen after the log-in based on the setting values.

### (Map of Storage Region)

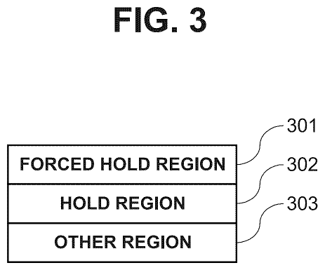

FIG. 3 is a map indicating classification of a storage region allocated in the HDD 204. Assume that the storage region in the HDD 204 is composed of the forced hold region 301, the hold region 302, and the other region 303.

### [Forced Hold Region]

The forced hold region 301 is a storage region in which print data received from the PC 102 is temporarily stored in a case where the image forming apparatus 101 is set to operate in the forced hold mode. Printing of the print data held in the forced hold region 301 can be instructed by only the user who has been authenticated by an authentication means (IC card authentication or keyboard authentication) in terms of security. More specifically, the username of the user who has logged in to the PC 102 is added to the print data transmitted from the PC 102, and the print data is held in the forced hold region 301 so that the username is association with the print data as a job owner name. In a case where the job owner name of the print data stored in the forced hold region 301 and the username of the user who has been authenticated by the above-mentioned authentication processing are matched with each other, the printing of the print data is permitted.

### [Hold Region]

The hold region 302 is a storage region for storing print data designated by the PC 102 to be stored in the hold region 302. The print data stored in the hold region 302 can be printed, edited, and deleted regardless of whether the user is the user who has been authenticated by the authentication means. However, the print data can be locked with a password and/or encrypted, as necessary. In the present exemplary embodiment, JDF print data is stored in the hold region 302, and normally, the JDF print data, which has been designated to be stored in the hold region 302, is stored in the hold region 302. In a case where the image forming apparatus 101 is set to operate in the forced hold mode, JDF print data that has not been designated to be stored in the hold region 302 is also forcibly held in the hold region 302. The forced hold mode is a function for perform personal authentication and for a security purpose. Meanwhile, the JDF is implemented in a production printer in many cases, and there is a use case where a plurality of users inputs data in the hold region 302 and one operator collectively performs printing. Since there is also a case where the user makes optimal settings of the image forming apparatus 101 while checking complicated print settings at the time of printing, only JDF print data is specially held in the hold region 302.

### [Other Region]

The other region 303 is a region other than the forced hold region 301 and the hold region 302.

### (Hold Print Screen)

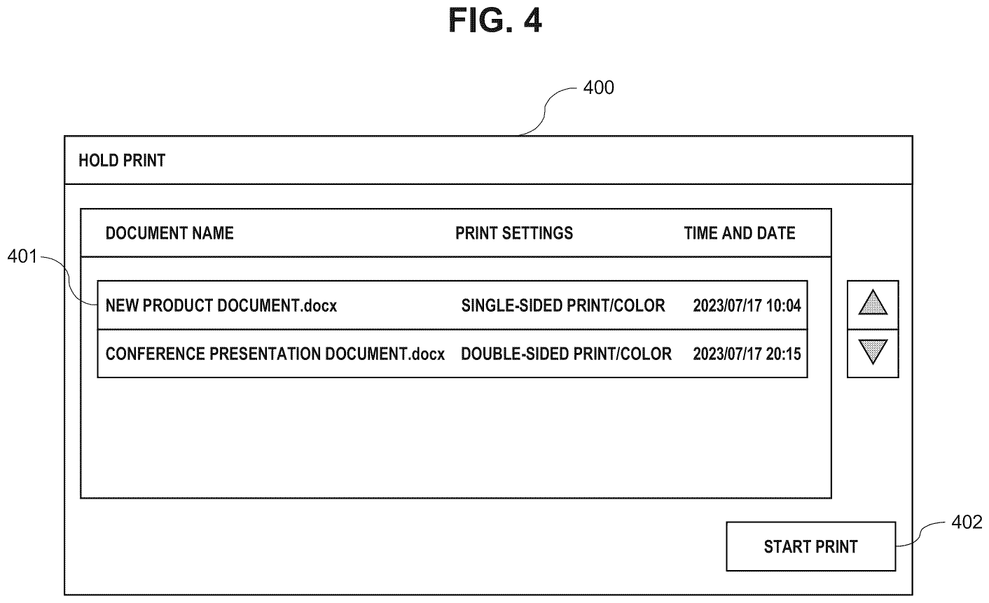

FIG. 4 illustrates a hold print screen 400 that displays a list of print jobs held in the forced hold region 301. In a case where the image forming apparatus 101 is operating in the forced hold mode, data of a print job (excluding a JDF print job) transmitted from the PC 102 is held in the forced hold region 301 of the HDD 204. The CPU 201 then reads a document name, print settings, and reception time and date, which are stored in association with data in the HDD 204, and displays the document name, the print settings, and the reception time and date on the operation unit 206.

In a case where the user selects a desired print job 401 from the list in FIG. 4 and presses a [START PRINT] button 402, the CPU 201 reads corresponding print data from the forced hold region 301 of the HDD 204 and causes the printer 209 to print the print data.

### (Hold Print Screen)

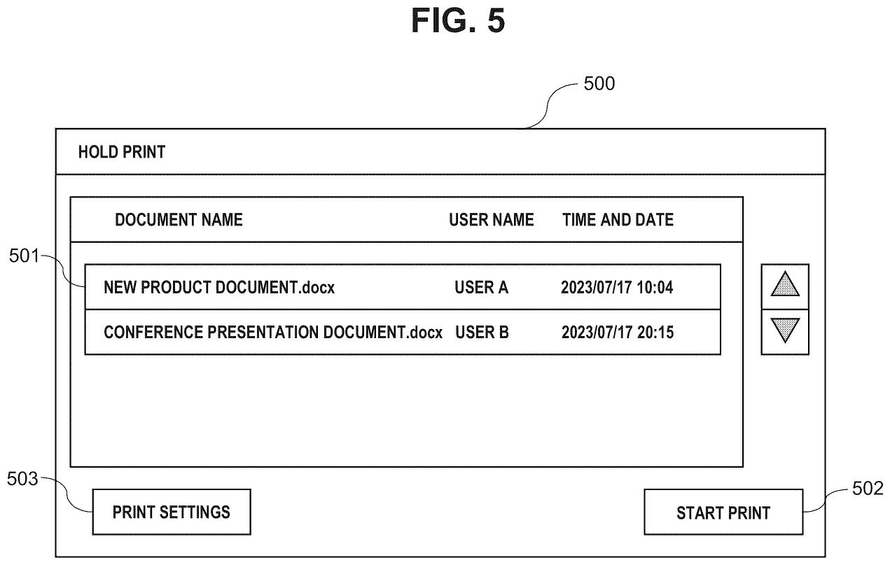

FIG. 5 illustrates a hold print screen 500 that displays a list of JDF print jobs held in the hold region 302. A JDF print job, which has been transmitted from the PC 102 and designated to be stored in the hold region 302, is held in the hold region 302 of the HDD 204. In the present exemplary embodiment, in the case where the image forming apparatus 101 is operating in the forced hold mode, all JDF print jobs that have been transmitted from the PC 102 are held not in the forced hold region 301 of the HDD 204 but in the hold region 302 of the HDD 204. The CPU 201 then reads a document name, print settings, and reception time and date, which are stored in association with data in the HDD 204, and displays the document name, the print settings, and the reception time and date on the operation unit 206. In a case where the user selects a desired JDF print job 501 from the list in FIG. 5 and presses a [START PRINT] button 502, the CPU 201 reads corresponding JDF print data from the hold region 302 of the HDD 204 and causes the printer 209 to print the print data.

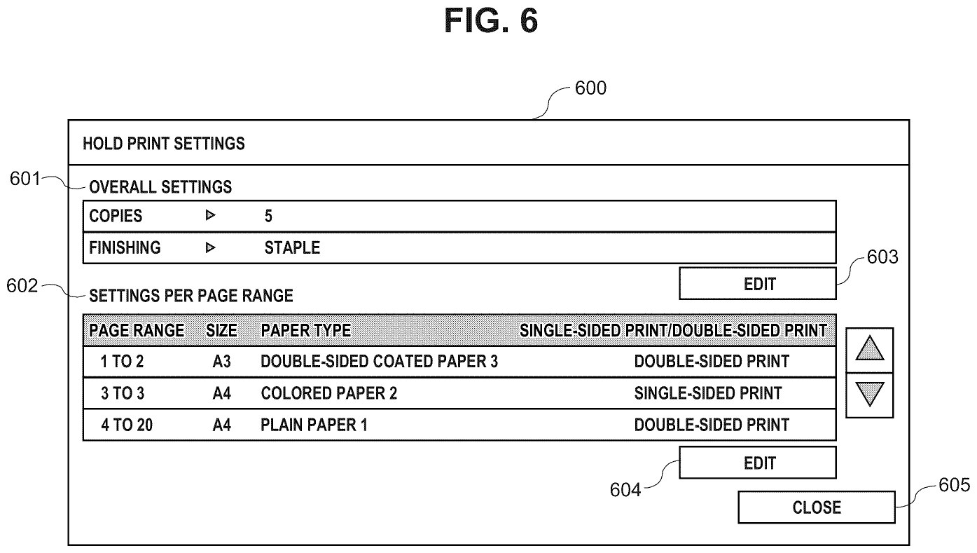

It is possible to designate a paper setting, an image layout setting, and the like in detail per page range. Thus, in the present exemplary embodiment, the user checks the JDF print job held in the hold region 302 by referring to the operation unit 206 of the image forming apparatus 101, and sets paper in the image forming apparatus 101. The user is able to change print settings of the JDF print job stored in the hold region 302, from the operation unit 206. In the case of referring to print settings of the JDF print job or changing a setting, the user selects the desired JDF print job 501 from the list in FIG. 5 and presses a [PRINT SETTINGS] button 503. When the [PRINT SETTINGS] button 503 is pressed, the CPU 201 reads the corresponding JDF print data from the hold region 302 of the HDD 204, and displays a hold print settings screen 600 illustrated in FIG. 6. The user is able to refer to and change the print settings from the hold print settings screen 600.

### (Hold Print Settings Screen)

FIG. 6 illustrates the hold print settings screen 600 for the JDF print job held in

the hold region 302. The print settings of the JDF print job 501 selected on the hold print screen 500 in FIG. 5 are read from the HDD 204 by the CPU 201 and displayed on the hold print settings screen 600 of the operation unit 206.

Overall settings 601 correspond to a partial display region of the print settings of the whole of the JDF print job.

In the present exemplary embodiment, the number of copies and finishing are displayed as representative print settings. Additionally, by pressing an “EDIT” button 603 in the overall settings 601, the hold print settings screen 600 transitions to a screen for changing the print settings of the whole of the JDF print job, and it becomes possible to change the print settings.

Settings per page range 602 correspond to a partial display region of the settings per page range of the JDF print job. Pages are separated into page ranges so that each page range has identical page settings values, and the page range and representative settings for the page range, namely, a paper size, a paper type, and single-sided print or double-sided print, are displayed. The user refers to the settings per page range 602, and can thereby check paper that should be put on a sheet feed deck of the image forming apparatus 101. Additionally, by selecting a page range from the settings per page range 602 and pressing an “EDIT” button 604 in the settings per page range 602, the hold print settings screen 600 transitions to a screen for changing the settings of the selected page range, and it becomes possible to change the print settings. For example, it is possible to change settings regarding the paper size, the paper type, the single-sided print or double-sided print for a page, image processing for the page, and the like.

A “CLOSE” button 605 is pressed in a case where the hold print settings screen 600 is closed to return to the hold print screen 500. At this time, the print settings of the JDF print job stored in the hold region 302 of the HDD 204 are overwritten with the print settings set on the hold print settings screen 600 by the CPU 201.

### (Forced Hold Setting Screen)

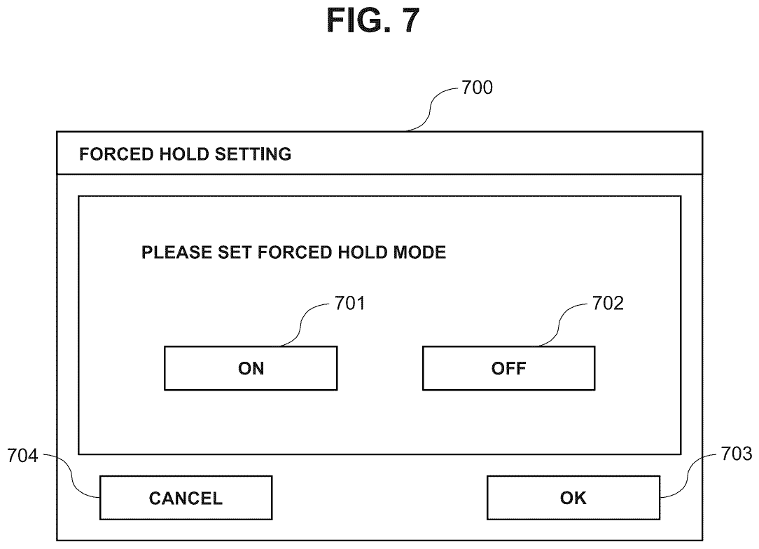

FIG. 7 illustrates a forced hold setting screen 700 for making a setting of the forced hold mode.

In a case where the user selects an “ON” button 701 and presses the “OK” button 703, the forced hold mode is enabled. In a case where the user selects an “OFF” button 702, the forced hold mode is disabled. In a case where the forced hold mode is enabled, received print data other than JDF print data is held in the forced hold region 301, and the JDF print data is held in the hold region 302. Note that setting values in FIG. 7 are stored in the HDD 204, and loaded into the RAM 202 at the time of startup of the image forming apparatus 101.

In the present exemplary embodiment, in a case where there is one setting of the forced hold mode and the forced hold mode is enabled, print data other than JDF print data is held in the forced hold region 301, and the JDF print data is held in the hold region 302. Note that another setting for holding the JDF print data in the hold region 302 may be provided other than the above-mentioned specified setting.

### (Data of Print Job)

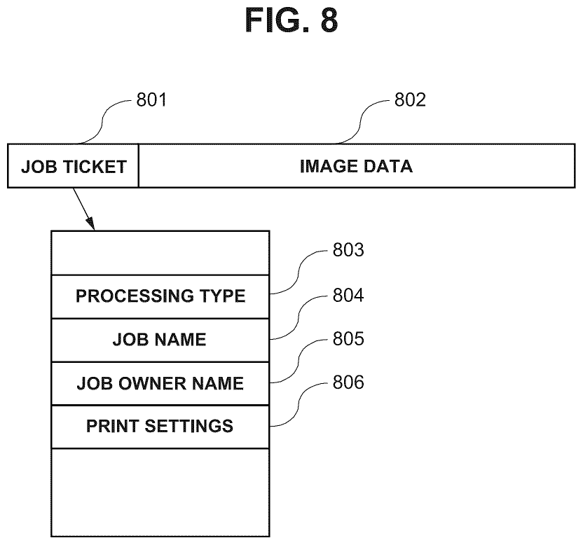

FIG. 8 is a diagram illustrating a data structure of a print job transmitted from the PC 102. Data of the print job is composed of a job ticket 801 and image data 802.

The job ticket 801 includes a processing type 803, a job name 804, a job owner name 805, and print settings 806. The job ticket 801 is a manufacturer-specific format that is added by a printer driver of the PC 102, or a JDF, which is a standard format in the printing industry.

The processing type 803 represents a method of outputting a print job, and indicates whether to print or store the print job and a storage destination (the forced hold region 301 or the hold region 302) in a case where the print job is to be stored.

The job name 804 represents a name of a job whose print data is to be printed.

The job owner name 805 represents a username of the user who has logged in to the PC 102.

The print settings 806 include settings of an output paper size, a document size, the number of copies, print orientation, finishing, and the like.

In the case of the JDF print data, the print settings 806 include all of the print settings displayed on the hold print settings screen 600.

The image data 802 to be printed is, for example, image data such as page description language (PDL) data.

Processing in Image Forming Apparatus when Receiving Print Job

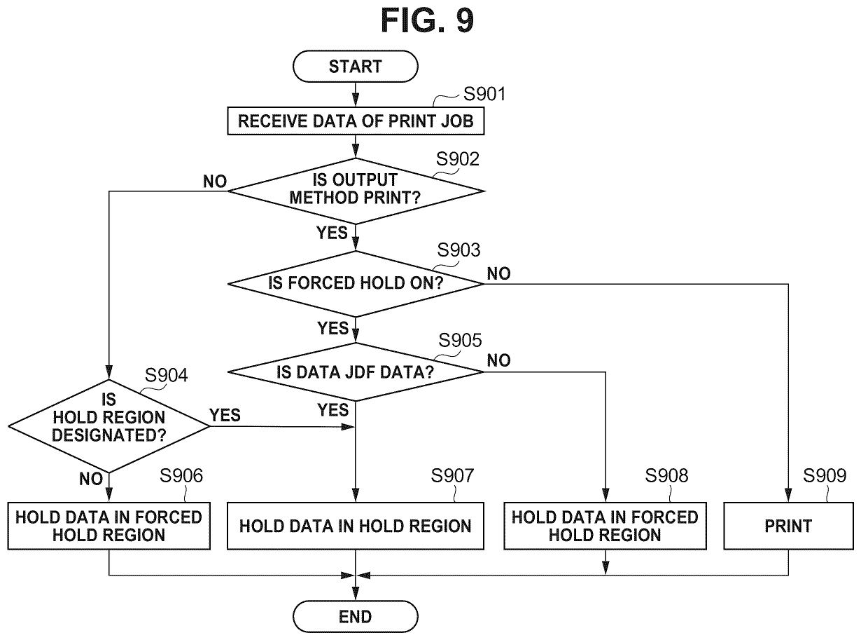

Processing performed when the image forming apparatus 101 receives print data from the PC 102 is now described with reference to FIG. 9. Each step in FIG. 9 is implemented by the CPU 201 executing a program loaded from the HDD 204 into the RAM 202. In the following description and the drawing, each step of the processing is denoted by “S”.

In step S901, first, the CPU 201 detects reception of data of a print job from the PC 102 via the network I/F 210, and analyzes the job ticket 801 added to the received data of the print job. At this time, the received data of the print job is stored in the other region 303 of the HDD 204.

In step S902, the CPU 201 determines whether an output method represented by the processing type 803 of the job ticket 801 is “print”. As the output method, there are a case where the print job is printed on an actual sheet and a case where print data is stored in the HDD 204, and, either “print” or “storage destination” in the case of storing the print data is designated in the processing type 803. In step S902, the CPU 201 determines whether the output method is “print” or something other than “print”. In a case where the CPU 201 determines that the output method is “print” (YES in step S902), the processing proceeds to step S903. Otherwise (NO in step S902), the processing proceeds to step S904.

In step S903, the CPU 201 checks whether forced hold is “ON” in a forced hold setting of the image forming apparatus 101. In a case where the forced hold is “ON” (YES in step S903), the processing proceeds to step S905. Otherwise (NO in step S903), the processing proceeds to step S909.

In step S904, the CPU 201 determines whether the hold region 302 is set as the storage destination in the processing type 803 in a case where the output method of the print data is “store”. In a case where the hold region 302 is set (YES in step S904), the processing proceeds to step S907. Otherwise (NO in step S904), the processing proceeds to step S906.

In step S905, the CPU 201 determines whether the received print data is JDF print data. In a case where the received print data is the JDF print data (YES in step S905), the processing proceeds to step $907. Otherwise (NO in step S905), the processing proceeds to step S908.

In steps S906 and S908, the CPU 201 moves the data of the print job received and stored in the other region 303 of the HDD 204 in step S901 to the forced hold region 301 and ends the processing.

In step S907, the CPU 201 moves the data of the print job stored in the other region 303 of the HDD 204 in step S901 to the hold region 302 and ends the processing.

In step S909, the CPU 201 performs raster image processing (RIP) on PDL data in the data of the print job to convert the data into a bitmap image, performs various kinds of image processing, instructs the printer 209 to perform printing, and ends the processing.

While the RIP is assumed to be performed at the time of printing in the present exemplary embodiment, the CPU 201 may perform the RIP before moving the data to the forced hold region 301 or the hold region 302 in step S906, S907, or S908, and may store the data subjected to the RIP in the forced hold region 301 or the hold region 302.

As described above, according to the present exemplary embodiment, the image forming apparatus that operates in the forced hold mode, when processing a print job in which a job ticket having complicated print settings is added to print data, such as a JDF print job, forcibly holds every print job in the hold region. At the time of printing the print job having complicated print settings and being held in the hold region, it becomes possible for the user to check the complicated print settings and make optimal settings of the image forming apparatus, which increases convenience.

While the description has been provided assuming that the JDF is a type of job ticket for which a storage region for holding print data is changed in the present exemplary embodiment, it goes without saying that the type of job ticket may be other than the JDF.

Alternatively, in which storage region the print data is to be forcibly held may be settable depending on the type of job ticket.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-161630, filed Sep. 25, 2023, which is hereby incorporated by reference herein in its entirety.

What is claimed is:

1. An image forming apparatus comprising:
a first storage unit configured to store print data, a print setting of the print data being unchangeable by a user;
a second storage unit configured to store print data, a print setting of the print data being changeable by the user;
a reception unit configured to receive print data; and
a control unit configured to:
in a case where a mode of storing the print data received by the reception unit and printing the stored print data after acceptance of a print instruction from the user is set and a format of the print data received by the reception unit is a first format, perform control to store the print data in the first format in the first storage unit, and
in a case where the mode is set and the format of the print data received by the reception unit is a second format, perform control to store the print data in the second format in the second storage unit.

2. The image forming apparatus according to claim 1, wherein the second format is a job definition format (JDF).

3. The image forming apparatus according to claim 1, wherein, in a case where the mode is not set, the control unit is configured to execute printing of the print data received by the reception unit without accepting the print instruction from the user.

4. The image forming apparatus according to claim 1, wherein the print setting is a setting of a number of copies.

5. The image forming apparatus according to claim 1, wherein the print setting is a setting of stapling.

6. The image forming apparatus according to claim 1, wherein the second storage unit is configured to be capable of changing a print setting of a whole of the stored print data and changing a print setting of partial pages of the stored print data.

7. The image forming apparatus according to claim 6, wherein the print setting of the partial pages of the print data is a setting of a type of paper to be used in printing.

8. The image forming apparatus according to claim 6, wherein the print setting of the partial pages of the print data is a setting of double-sided print.

9. The image forming apparatus according to claim 6, wherein the print setting of the partial pages of the print data is a setting of image processing.

10. The image forming apparatus according to claim 1, wherein, in a case where the second storage unit is designated in the print data received by the reception unit, the control unit is configured to perform control to store the print data in the second storage unit regardless of the format of the print data.

11. A method of controlling an image forming apparatus including at least a first storage unit configured to store print data, a print setting of the print data being unchangeable by a user, and a second storage unit configured to store print data, a print setting of the print data being changeable by the user, the method comprising:
receiving print data; and
performing,
in a case where a mode of storing the received print data and printing the stored print data after acceptance of a print instruction from the user is set and a format of the received print data is a first format, control to store the print data in the first format in the first storage unit, and
in a case where the mode is set and the format of the received print data is a second format, control to store the print data in the second format in the second storage unit.

12. A non-transitory computer-readable storage medium storing one or more programs including instructions, which when executed by one or more processors of an image forming apparatus including at least a first storage unit configured to store print data, a print setting of the print data being unchangeable by a user, and a second storage unit configured to store print data, a print setting of the print data being changeable by the user, cause the image forming apparatus to perform a method comprising:
receiving print data; and
performing,
in a case where a mode of storing the received print data and printing the stored print data after acceptance of a print instruction from the user is set and a format of the received print data is a first format, control to store the print data in the first format in the first storage unit, and
in a case where the mode is set and the format of the received print data is a second format, control to store the print data in the second format in the second storage unit.
